(19) United States
(12) Patent Application Publication
(10) Pub. No.: US 2009/0005084 A1
(43) Pub. Date: Jan. 1, 2009

(54) METHOD AND APPARATUS FOR POSITIONNG USING ATSC DIGITAL TV SIGNALS

(75) Inventor: LIN YANG, FREMONT, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 11/770,651

(22) Filed: Jun. 28, 2007

(51) Int. Cl. H04Q 7/20

(52) U.S. Cl. 455/456.6

(57) ABSTRACT

An apparatus for positioning comprising a method is provided. The method includes the step of calculating a transmission time of a training sequence of a television signal from a transmitter to a mobile receiver.

### FIELD OF THE INVENTION

The present invention relates generally to locationing or determining the exact location of a fixed or moving object, more specifically the present invention relates to using the ATSC digital TV signals for positioning.

### BACKGROUND

Locationing using GPS signals is known. However, GPS has drawbacks such as lack of coverage in in-door environment and out-door environment among high-rise buildings.

Digital TV signals are known to be used for receiving digital programs for watching. However, digital signals are known to be used for locationing purposes with significant improvement over GPS. U.S. published patent application No. 20020135518 to Matthew Rabinowitz, et al describes a computer program product, apparatus, and method for use in determining the position of a user terminal that includes receiving at the user terminal a digital television (DTV) broadcast signal transmitted by a DTV transmitter; tracking a periodic component of the DTV signal using a delay lock loop (DLL), including selecting an observation interval based on the timing of the periodic component, and turning on a portion of the DLL during the observation interval, and turning the portion off otherwise; and determining a pseudo-range between the user terminal and the DTV transmitter based on the DTV broadcast signal; and wherein the position of the user terminal is determined based on the pseudo-range and a location of the DTV transmitter. Further, the pseudo-range is determined based on a known digital sequence in the ATSC signal frame. As can be seen, pilot signal for ATSC is a training sequence. Pilot is defined as known signal in general. However, the pilot signal for ATSC or a training sequence is insufficient for determining a distance for positioning purposes without elaborate scheme. Furthermore, extra devices other than exiting components of a DTV receiver are required for positioning. Therefore, the Rabinowitz system is costly and requires more devices.

There is need for using existing components of an exiting DTV receiver without any position specific devices such as an assistant base station. A need exists for a system that not only uses only a part ATSC signal (i.e. the known training sequences), but also the entire ATSC signal (the known training sequences and the restored unknown data) for the positioning purpose.

### SUMMARY OF THE INVENTION

A method and device for positioning using Advanced Television Systems Committee (ATSC) digital TV signals are provided.

A method and device for positioning using ATSC digital TV signals comprising both known signal and restored program data are provided.

A method and device for positioning using existing components of a DTV receiver are provided.

A method and device for positioning using existing components of an Advanced Television Systems Committee (ATSC) type DTV receiver are provided.

An apparatus for positioning comprising a method including the step of: calculating a transmission time of a training sequence and restored program data of a television signal from a transmitter to a mobile receiver.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1. is an example position locationing system in accordance with some embodiments of the invention.

FIG. 2 is an example digital television signal in accordance with some embodiments of the invention.

FIG. 3 is an example position locationing device in accordance with some embodiments of the invention.

FIG. 4 is an example of a flowchart in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to calculating a transmission time of a training sequence and restored program data of a television signal from a transmitter to a mobile receiver. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of positioning using calculating a transmission time of a training sequence and restored program data of a television signal from a transmitter to a mobile receiver. The non-processor circuits may include, but are not limited to, a radio receiver, a radio transmitter, signal drivers, clock circuits, power source circuits, and user input devices. As such, these functions may be interpreted as steps of a method to perform calculating a transmission time of a training sequence and restored program data of a television signal from a transmitter to a mobile receiver. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

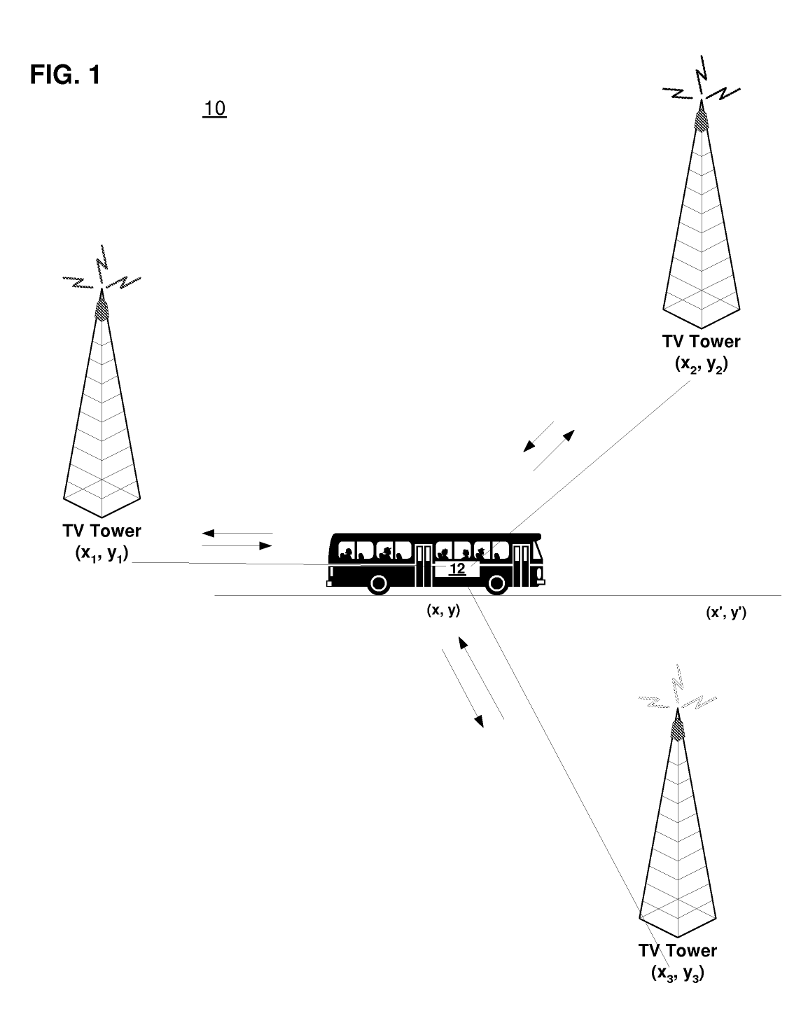

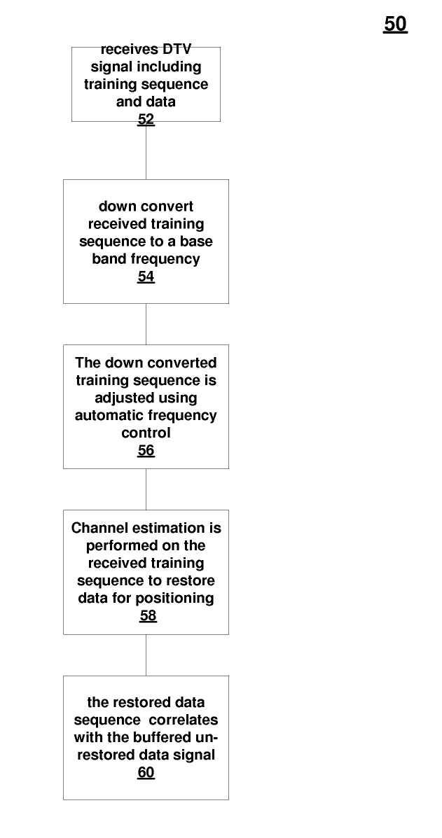

Referring to FIGS. 1-4, depictions of the present invention are shown. A positioning system 4 using digital television (DTV) signals is shown. Three DTV transmitters are provided. They are respectively: transmitter tower 1 having a predetermined position of (x₁, y₁); transmitter tower 2 having a predetermined position of (x₂, y₂); and transmitter tower 3 having a predetermined position of (x₃, y₃). A moving object 6 such as a moving vehicle having users carrying hand held devices is provided. Moving object 6 has a variable position (x, y). The positioning of moving object 6 comprises determine the position (x, y) at time t. Typically, the distance d₁ is defined as the distance between (x₁, y₁) and (x, y). Similarly, d₂ is defined as the distance between (x₂, y₂) and (x, y); as well as d₃ being the distance between (x₃, y₃) and (x, y). As can be seen when moving object 6 moves to a new point (x′, y′), distances between (x₁, y₁) and (x′, y′) changes. Similarly, new d₂ and d₃ need to be derived. Using the three towers each having known position to derive a positioning of moving object 6 is shown in detail in FIG. 3. Once the distance is known, the positioning of moving object 6 can be derived using any type of positioning in a known manner such as triangulation, etc.

As can be seen, only a two dimensional (2D) scheme is shown. However, the present invention contemplates a three dimensional (3D) scheme as well by introducing a third variable z such that d₁-d₃ is define on a 3D co-ordinate or space with d₁ being the distance between (x₁, y₁, z₁) and (x, y, z). Similarly, d₂ being the distance between (x₂, y₂, z₂) and (x, y, z); and d₃ being the distance between (x₃, y₃, z₃) and (x, y, z).

It is noted that unknown data segments are so referred because a mobile receiver does not know the various parameter including timing or clock info related therewith. For example, data segments or part of a DTV program information may constantly change. Therefore, data segments are unknown as compared to pilot signals that are known. In addition, unknown data segments typically occupy more space or takes more time than a typical pilot signal as the purpose of the DTV information is for a viewer to watch DTV programs which comprises virtually all of the unknown data segments. By way of an example, in a DTV system, the time between two known adjacent pilots is 24 milliseconds (ms). On the other hand, by using embodiment from the present invention, the whole feedback scheme can be done within about 1-2 ms.

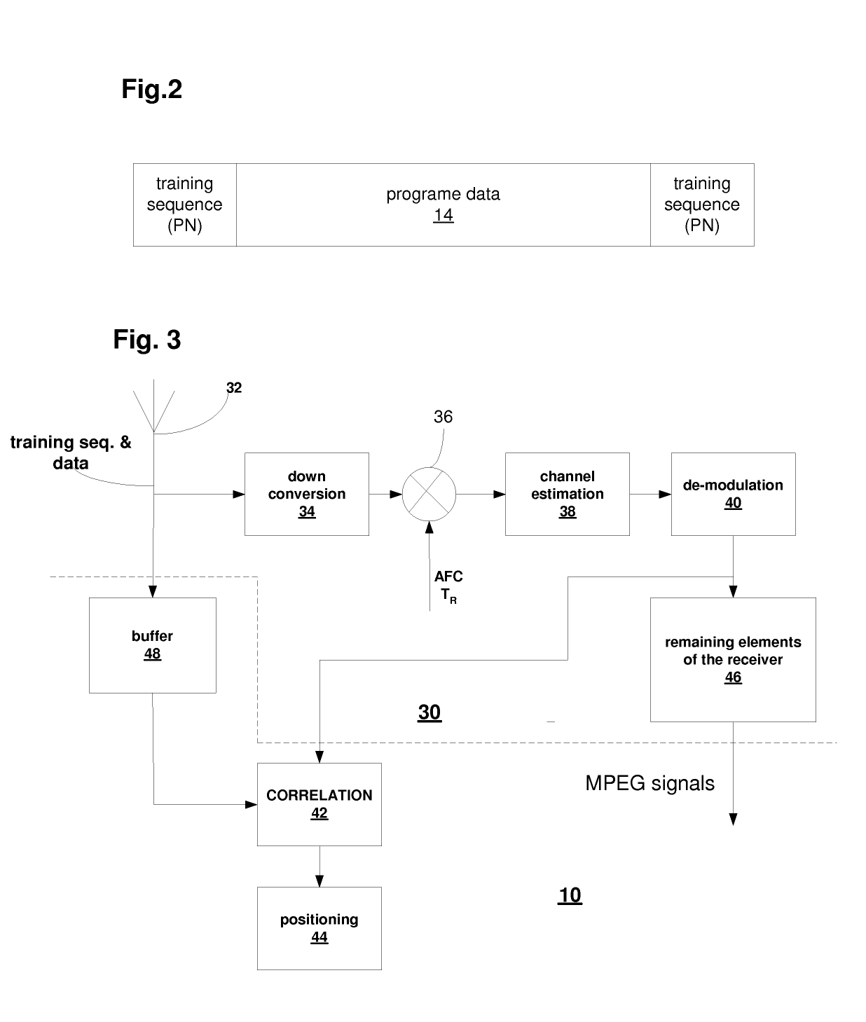

In FIG. 2, a depiction of a part of a frame in an DTV communication systems having training sequences interposed between program data 14 (only one shown) is provided. The unknown program data 14 comprise the information adapted to carry TV programming information. Typically, in an ATSC system the time interval between training sequences limited. For example, about 24 milliseconds (ms) such that using only the known training sequences for positioning is insufficient or requires more elaborate devices. However, the unknown program data 14 can become known using a typical DTV receiver. For details of rendering the unknown program data 14 for positioning, see FIG. 3.

In FIG. 3, a scheme 10 of using at least part of a receiver 30 is shown. An antenna 32 receives wireless signals including known training sequences and unknown program data. PN training sequences are down converted into base band 34. The down converted base band PN signals are subjected to a comparator 36 by a feedback correction based upon the existing known parameters of the received PN training sequences. The feedback may be associated with or using automatic frequency correction (AFC). The compared signal in turn goes through channel estimation 38 and demodulation 40. At this juncture, the unknown program data are restored and therefore became known. Furthermore, the known program data go through two paths, path 1 and path 2. In path 1, the known or processed program data is correlated 42 with the received signal from antenna 32 stored in a buffer 48. One reason for the need for the buffer is that the restored data went through a time delay. Typically, this time delay is in milliseconds (ms). The correlated or compared signal is used for positioning in block 44. In path 2, the correlated signal goes through a block 46 containing typical elements of a receiver such as a DTV receiver including forward error corrections (FEC).

Referring specifically to block 44, the training sequences and the restored data are used for the processing of a positioning system. Typically, in an ATSC system, the time interval between known training sequences is so short that relying solely upon same for positioning is impractical or at least requires additional devices such as assistance base station or stations. However, a DTV receiver is inherently capable of restoring data thereby rendering the data to known information that can be used for positioning as well. Therefore, both training sequences and restored data are known; hence both can be used for positioning purposes.

The distances d₁, d₂, and d₃ or the value of (x, y, z) may be measured as follows. By receiving from the 3 TV transmitters TV signals, a time offset between a local clock of that TV transmitter and a reference clock is established. The reference clock may be derived from GPS signals. The use of a reference clock permits the determination of the time offset for each TV transmitter when multiple monitor units (only one shown) are used. Because each monitor unit can determine the time offset with respect to the reference clock, the offsets in the local clocks of the monitor units do not affect these determinations. Alternatively, no external time reference is needed. According to this implementation, a single monitor unit receives TV signals from all three TV transmitters. The single monitor is a built-in device within a user terminal. In effect, the local clock of the single monitor unit functions as the time reference. The single monitor unit and the user terminal are combined as a single unit.

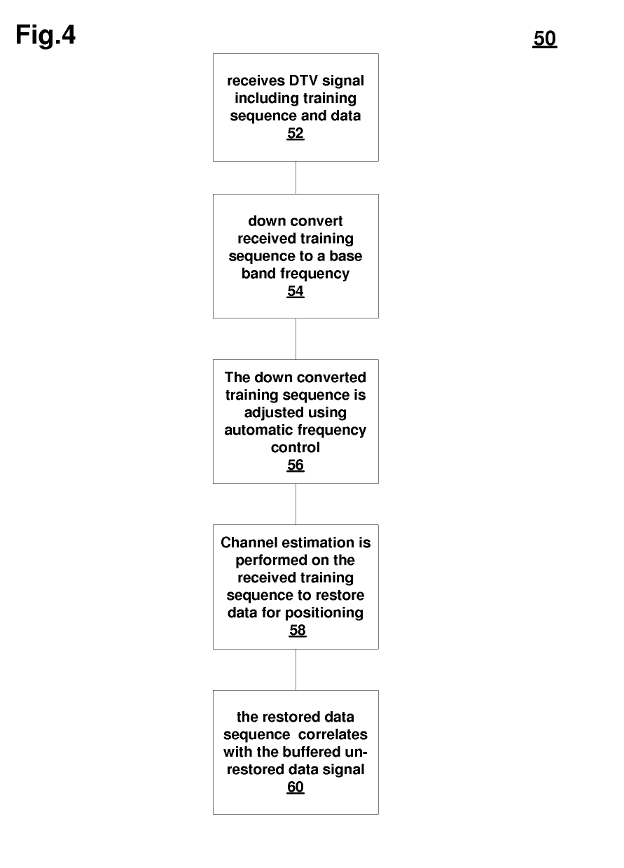

Referring to FIG. 4, a flowchart 50 of the present invention is shown. Flowchart 50 depicts a method for positioning comprising the step of calculating a transmission time of a training sequence of a television signal from a transmitter to a mobile receiver. The transmitter comprises a DTV transmitter. Initially, a receiving side that may be part of a known receiver receives the training sequence of the television signal among a plurality of training sequences such as training PN sequences disposed therebetween (Step 52). The received training sequence down converted to a base band frequency for further processing (Step 54). The down converted training sequence is adjusted using automatic frequency control (Step 56). Channel estimation and demodulation are performed on the received training sequence based upon a set of known parameters (Step 58). At this juncture, the program data is restored and therefore can be used positioning purposes along with training sequences. The received training sequence along with the restored data is further correlated with a buffered received signal including training sequence as well as non-restored data (Step 60). The present invention advantageously and additionally uses the restored data as well as training sequence for positioning purposes. The processed training sequence and restored data obtained from a typical DTV receiver are used for calculating the transmission time between a transmission tower and the mobile user within a neighborhood of a specific time period. If two or preferably three transmission tower exists, the position of the mobile user can be derived or calculated using such known method as triangulation, and the like.

The apparatus contemplated in the present invention may be part of a DTV receiver, an ATSC DTV receiver, or a stand alone device having relevant DTV elements used exclusively for positioning. However, in the preferred embodiment of the present invention, it is contemplated that only existing components of an exiting DTV receiver, preferably an ATSC receiver, is used. In other words, the feedback decoded signal is used. No assistant base station of the prior art as described in the Background section is contemplated. It is noted that the present invention does not use a subset of training sequence, but contemplates using any DTV ATSC signal for positioning.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A method for positioning comprising the step of calculating a transmission time of a training sequence and restored program data of a television signal from a transmitter to a mobile receiver.

2. The method of claim 1 further comprising the steps of:
receiving the training sequence of the television signal;
performing a channel estimation based upon the received training sequence to restore the program data; and
using the estimated training sequence and the restored program data for calculating the transmission time.

3. The method of claim 1 further comprising the step of correlating or comparing the received training sequence with a buffered received signal for suitable comparison.

4. The method of claim 1 further comprising the step of down converting the received training sequence to a base band frequency.

5. The method of claim 4 further comprising the step of adjusting the down converted training sequence using automatic frequency control.

6. The method of claim 1, wherein the training sequence is distributed between two data segments.

7. The method of claim 1, wherein the transmitter comprises an ATSC DTV transmitter.

8. An apparatus for positioning comprising a method including the step of: calculating a transmission time of a training sequence and restored program data of a television signal from a transmitter to a mobile receiver.

9. The apparatus of claim 8, wherein the method further comprising the steps of:
receiving the Training sequence of the television signal;
performing a channel estimation based upon the received Training sequence to restore the program data; and
using the estimated Training sequence and the restored program data for calculating the transmission time.

10. The apparatus of claim 8, wherein the method further comprising the step of correlating or comparing the received training sequence with a buffered received signal for suitable comparison.

11. The apparatus of claim 8, wherein the method further comprising the step of down converting the received Training sequence to a base band frequency.

12. The apparatus of claim 11, wherein the method further comprising the step of adjusting the down converted Training sequence using automatic frequency control.

13. The apparatus of claim 8, wherein the Training sequence is disposed between two data segments.

14. The apparatus of claim 8, wherein the apparatus comprises at least a part of an ATSC DTV transmitter.
